(19) United States
(12) Patent Application Publication
(10) Pub. No.: US 2015/0098720 A1
(43) Pub. Date: Apr. 9, 2015

(54) IMAGE FORMING APPARATUS

(71) Applicant: CANON KABUSHIKI KAISHA, Tokyo (JP)

(72) Inventors: Ryota Matsumoto, Yokohama-shi (JP); Koichi Hashimoto, Yokohama-shi (JP); Yuki Narumi, Hiratsuka-shi (JP); Masatsugu Toyonori, Yokohama-shi (JP)

(21) Appl. No.: 14/571,742

(22) Filed: Dec. 16, 2014

Related U.S. Application Data
(63) Continuation of application No. PCT/JP2013/067739, filed on Jun. 21, 2013.

(30) Foreign Application Priority Data
Jun. 22, 2012 (JP) 2012-141214

(51) Int. Cl. G03G 15/02

(52) U.S. Cl. CPC G03G 15/0266
USPC 399/50

(57) ABSTRACT

There is provided an image forming apparatus including: a rotatable photosensitive member; a rotatable charging brush for electrically charging the photosensitive member by injecting electric charges into a surface of the photosensitive member in contact with the surface of the photosensitive member; a power source for applying a voltage to the charging brush; a potential sensor for detecting a surface potential of the photosensitive member; an executing portion for causing the potential sensor to execute detection in such a manner that after a first potential which is the potential of the photosensitive member charged by applying a first voltage to the charging brush is detected by the potential sensor, the electric charges are removed from the photosensitive member by applying a second voltage smaller in absolute value than the first potential to the charging brush, and then a second potential which is the potential of the photosensitive member after removal of the electric charges is detected by the potential sensor; and a notifying portion for providing notification of information on a lifetime of the charging brush or information on exchange of the charging brush on the basis of the first potential and the second potential.

### TECHNICAL FIELD

The present invention relates to an image forming apparatus of an electrophotographic type.

Incidentally, as the image forming apparatus of the electrophotographic type, an electrophotographic copying machine, an electrophotographic printer, a facsimile device, a word processor, multi-function machines of these, and the like are included.

### BACKGROUND ART

In the image forming apparatus of the electrophotographic type, a charging means for electrically charging a surface of an electrophotographic photosensitive member (photosensitive member) uniformly is provided. As a charging system of the charging means, a corona charging system using an electric discharge phenomenon, a roller charging system, and the like have been known. However, in the charging system using the electric discharge phenomenon, an image quality is lowered due to an electric discharge product in some cases.

On the other hand, as a charging system (type) not using the electric discharge phenomenon, an injection charging system has been known. The injection charging system is a system in which a predetermined charging bias is applied to an electroconductive charging member, contacting the photosensitive member, such as a charging roller, a fur brush, a magnetic brush or a blade and thus electric charges are directly injected from the charging member into a member-to-be-charged to electrically charge a surface of the member-to-be-charged.

The injection charging system does not use the electric discharge phenomenon, and therefore the electric discharge product is not formed, so that the lowering in image quality due to the electric discharge product is not caused to occur. A charging phenomenon of the photosensitive member in the injection charging system can be approximated to a charging phenomenon of a capacitor including an electroconductive substrate of the photosensitive member and a contact region of a charging member as electrodes. In order to stably perform uniform charging, it is desirable that a surface potential of the photosensitive member sufficiently converges to a voltage applied to the charging member.

However, in some cases, energization deterioration of the charging member due to an increase in use amount and contamination of the charging member with a substance, having a high electric resistance, such as a toner r an external additive for the toner progress. Then, the electric resistance of the charging member increases and charging power lowers, and therefore the surface potential of the photosensitive member does not converge to the voltage applied to the charging member and causes potential non-uniformity.

Japanese Laid-Open Patent Application (JP-A) 2001-117320 discloses, a charging member of a contact type, a fur brush roller as a charging brush constituted by winding a fiber-planted base cloth.

### SUMMARY OF THE INVENTION

### Problem to be Solved by the Invention

In the case where the fur brush roller as described in JP-A 2011-117320 is used as the charging brush for the injection charging, in the image forming apparatus of the injection charging type (system), a contact frequency of filaments (fibers) in the charging brush capable of injecting electric charges lowers in some cases due to a local increase in electric resistance of the charging brush by a deposited product such as the toner or the external additive for the toner and due to (partial) lack (drop) of the charging member by an increase in use amount.

When the contact frequency of the filaments capable of injecting the electric charges is not sufficient, and uncharged region of the photosensitive member becomes large to become a factor of the potential non-uniformity. Then, when the potential non-uniformity of the photosensitive member due to the lowering in contact frequency of the filaments capable of injecting the electric charges becomes large, the image quality is lowered. For that reason, it is desirable that a magnitude of the potential non-uniformity is evaluated and then the charging brush is exchanged (replaced) before the image quality is lowered.

However, this potential non-uniformity results from an insufficient contact frequency of the filaments in the charging brush capable of injecting the electric charges, and therefore a spatial period of the potential non-uniformity is very minute, so that it is difficult to directly evaluate the potential non-uniformity by a potential sensor or an ammeter.

Accordingly, in the case of the apparatus of the injection charging type in which the minute potential non-uniformity of the photosensitive member becomes large by use and causes the lowering in image quality, in order to maintain the image quality at a good level for a long term, it is desirable that the charging member is exchanged when the minute potential non uniformity of the photosensitive member becomes large and the image quality starts the lowering therein.

Although a time for exchange is determined in advance by predicting the deterioration of the charging member, the deterioration of the charging brush largely fluctuates depending on an output image and an operation environment, and therefore it is difficult to efficiently use the charging brush.

Accordingly, an object of the present invention is to provide an image forming apparatus is capable of detecting minute potential non-uniformity of a photosensitive member due to deterioration of a charging brush.

### Means for Solving the Problems

The above object is accomplished by the image forming apparatus according to the present invention.

A first aspect of the present invention is an image forming apparatus comprising: a rotatable photosensitive member; a charging brush for electrically charging the photosensitive member by injecting electric charges into a surface of the photosensitive member in contact with the surface of the photosensitive member; a power source for applying a voltage to the charging brush; a potential sensor for detecting a surface potential of the photosensitive member; an executing portion for causing the potential sensor to execute detection in such a manner that after a first potential which is the potential of the photosensitive member charged by applying a first voltage to the charging brush is detected by the potential sensor, the electric charges are removed from the photosensitive member by applying a second voltage smaller in absolute value than the first potential to the charging brush, and then a second potential which is the potential of the photosensitive member after removal of the electric charges is detected by the potential sensor; and a notifying portion for providing notification of information on a lifetime of the charging brush or information on exchange of the charging brush on the basis of the first potential and the second potential.

Further, a second aspect of the present invention is an image forming apparatus comprising: a rotatable photosensitive member; a charging brush for electrically charging the photosensitive member by injecting electric charges into a surface of the photosensitive member in contact with the surface of the photosensitive member; a power source for applying a voltage to the charging brush; a potential sensor for detecting a surface potential of the photosensitive member; an executing portion for causing the potential sensor to execute detection in such a manner that after a first potential which is the potential of the photosensitive member charged by applying a first voltage to the charging brush is detected by the potential sensor, the electric charges are removed from the photosensitive member by applying a second voltage smaller in absolute value than the first potential to the charging brush, and then a second potential which is the potential of the photosensitive member after removal of the electric charges is detected by the potential sensor; and a controller controlling a relative speed of the charging brush relative to the photosensitive member on the basis of the first potential and the second potential.

### Effect of the Invention

According to the present invention, it is possible to detect the minute potential non-uniformity of the photosensitive member due to the deterioration of the charging member.

### BRIEF DESCRIPTION OF THE DRAWINGS

FIG. 1 is a schematic sectional view showing a schematic structure of an image forming apparatus according to an embodiment of the present invention.

FIG. 2 is a graph showing a relationship between the number of image output sheets (image output sheet number) and graininess in the embodiment of the present invention.

FIG. 3 is a graph showing a relationship between the image output sheet number and a charging rate in the embodiment of the present invention.

FIG. 4 includes schematic views showing filament states of a fur brush roller before and after a durability test.

FIG. 5 is a graph showing a relationship between a planted fiber density and the graininess in the embodiment of the present invention.

FIG. 6 is a graph showing a relationship between the planted fiber density and the charging rate in the embodiment.

FIG. 7 includes schematic views each showing a relationship between a contact frequency and a state of electric force line.

FIG. 8 includes schematic views showing behavior of charging and charge removal of a photosensitive member in a state in which the fur brush roller is not deteriorated.

FIG. 9 includes schematic views showing behavior of the charging and the charge removal of the photosensitive member in a state in which the fur brush roller is deteriorated.

FIG. 10 is a timing chart for illustrating an evaluation sequence for obtaining a potential non-uniformity index.

FIG. 11 is a graph showing a relationship between the image output sheet number and the potential non-uniformity index in the embodiment of the present invention.

FIG. 12 is a graph showing a relationship between the potential non-uniformity index and the graininess in the embodiment of the present invention.

FIG. 13 is a graph showing a relationship between the image output sheet number and the graininess in the embodiment of the present invention.

FIG. 14 is a graph showing a relationship between the image output sheet number and the potential non-uniformity index.

FIG. 15 is a graph showing a relationship between the image output sheet number and the graininess of fur brush rollers after exchange in the embodiment of the present invention.

FIG. 16 is a graph showing a relationship between a potential non-uniformity index and graininess in another embodiment of the present invention.

FIG. 17 is a graph showing a relationship between an image output sheet number and the graininess in the another embodiment of the present invention.

FIG. 18 is a graph showing a relationship between the image output sheet number and the potential non-uniformity index in the anther embodiment of the present invention.

FIG. 19 is a graph showing a relationship between the image output sheet number and the graininess of fur brush rollers after exchange in the another embodiment of the present invention.

FIG. 20 is a graph showing a relationship between a planted fiber density and a potential non-uniformity index in a further embodiment of the present invention.

FIG. 21 is a graph showing a relationship between an image output sheet number and graininess in the further embodiment of the present invention.

FIG. 22 is a graph showing a relationship between the image output sheet number and the potential non-uniformity index in the further embodiment of the present invention.

FIG. 23 is a block diagram showing a schematic control example of a principal part of the image forming apparatus according to the embodiment of the present invention.

FIG. 24 is a flowchart (diagram) showing a procedure of exchange notification control of the fur brush roller in the embodiment of the present invention.

FIG. 25 is a flowchart showing a procedure of control of a relative speed between the fur brush roller and a photosensitive member in the another embodiment of the present invention.

### EMBODIMENTS FOR CARRYING OUT THE INVENTION

in the following, the image forming apparatus according to the present invention will be specifically described in accordance with the drawings.

### Embodiment 1

### 1. General Structure and Output of Image Forming Apparatus

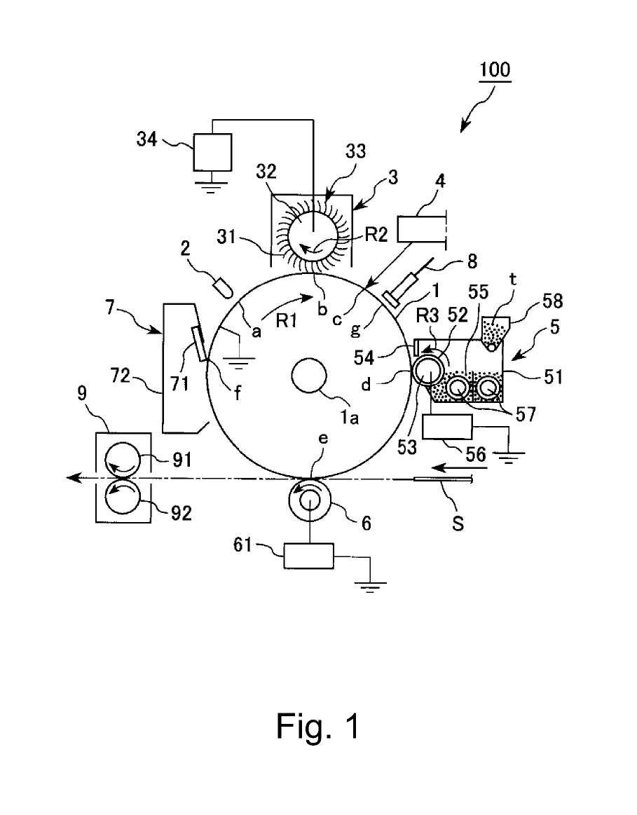

FIG. 1 is a schematic view showing a schematic structure of an image forming apparatus according to an embodiment of the present invention. In this embodiment, an image forming apparatus 100 is an electrophotographic-type image forming apparatus employing a fur brush charging system (type), a reversal development system (type), and a transfer system (type).

The image forming apparatus 100 includes a photosensitive drum 1 as a photosensitive member movable at a surface thereof. On this photosensitive drum 1, a toner image corresponding to image information is formed. The toner image formed on the surface of the photosensitive drum 1 is transferred onto a recording material S such as a sheet or OHP sheet. Then, this recording material S is introduced into a fixing device 9 as a fixing means, in which a fixing process for changing an unfixed toner image into a fixed image and then the recording material S is discharged as an image-formed product.

In the following, each of elements of the image forming apparatus 100 will be specifically described.

The photosensitive drum 1 is a drum-shaped electrophotographic photosensitive member as a rotatable member provided rotatably about a center shaft 1a. The photosensitive drum 1 is rotationally driven in an arrow R1 direction (clockwise) in the figure at a predetermined peripheral speed (surface movement speed). In this embodiment, the peripheral speed of the photosensitive drum 1 is 300 mm/sec.

In this embodiment, the photosensitive drum 1 is a negatively chargeable OPC photosensitive member. This photosensitive drum 1 is constituted by providing, on an aluminum-made drum-shaped electroconductive support (hereinafter referred to as an “aluminum support”), the following five (first to fifth) functional layers in a listed order from below.

The first layer is an undercoat layer. This undercoat layer is an about 20 μm-thick electroconductive layer provided for eliminating a defect of the aluminum support and for preventing generation of moire due to reflection of laser exposure light.

The second layer is a positive electric charge injection prevention layer. This positive electric charge injection prevention layer is an about 1 μm-thick medium resistance layer which performs the function of preventing a positive electric charge injected from the aluminum support from canceling a negative electric charge charged at the photosensitive member surface and in which an electric resistance is adjusted to about 10⁶ Ω·cm by amilan resin and methoxy methylated nylon.

The third layer is an electric charge injection layer. The electric charge injection layer is a 0.3 μm-thick layer in which a pigment of a disazo type is dispersed in a resin and generates a positive and negative electric charge pair by being subjected to laser light exposure.

The fourth layer is an electric charge transport layer. This electric charge transport layer contains hydrazone dispersed in polycarbonate resin, and is a P-type semiconductor. Accordingly, the negative electric charge charged at the surface of the photosensitive drum 1 cannot move from this layer but can transport only the positive electric charge generated in an electric charge generation layer to the surface of the photosensitive drum 1.

The fifth layer is an electric charge injection layer. This electric charge injection layer is an about 3 μm-thick coating layer of a material in which 70 wt. % of a light-transmissive electroconductive filler is dispersed in a photo-curable acrylic resin as a binder. As the electroconductive filler, ultrafine particles of tin oxide in which a low resistance (electroconductivity) is provided by doping tin oxide with antimony and which have a particle size of 0.03 μm are used. A volume resistivity of this electric charge injection layer may preferably be 1×10¹⁰-1×10¹⁴ Ω·cm which is a condition in which a sufficient charging property is obtained and image flow is not caused. In this embodiment, the photosensitive drum 1 in which the volume resistance of the electric charge injection layer is 1×10¹¹ Ω·cm was used.

The image forming apparatus 100 includes, at a periphery of the photosensitive drum 1, the following various process means actable on the photosensitive drum 1 provided in a listed order along a rotational direction of the photosensitive drum 1. First, there is a pre-exposure lamp (eraser lamp) 2 as a charge removing means (discharging means). Next, there is a fur brush charger 3 as a charging brush. Next, there is an exposure device 4 as an image exposure. Next, there is a developing device 5 as a developing means. Next, there is a transfer roller 6 which is a roller-shaped transfer member as a transfer means. Next, there is a cleaning device (blade cleaning device) 7 as a cleaning means.

The surface of the photosensitive drum 1 rotationally driven is charge-removed (discharged) by the pre-exposure lamp 2. A light irradiation position by the pre-exposure lamp 2 with respect to the rotational direction of the photosensitive drum 1 is a charge-removing part (discharging part) a. The pre-exposure lamp 2 is used for erasing an electrical memory remaining on the surface of the photosensitive drum 1 by the last image formation. In this embodiment, the pre-exposure lamp 2 exposes, to light, a whole surface of the photosensitive drum 1 by using an LED of 600 nm in wavelength.

The surface of the photosensitive drum 1 charge-removed by the pre-exposure lamp 2 is electrically charged uniformly to a predetermined polarity (negative polarity in this embodiment) and a predetermined potential by the fur brush charger 3. The fur brush charger 3 includes a fur brush roller 33, au a charging brush formed in a roller shape as a whole, in which filaments 31 are provided and planted no a peripheral surface of a charging sleeve 32 as a cylindrical supporting member. A rotational axis direction of the fur brush roller 33 and a rotational axis direction of the photosensitive drum 1 are substantially parallel to each other.

As a species of yarn of the filaments 31 constituting the fur brush roller 33, nylon of 6 tex, i.e., 6 g per 10,000 m was used. An original yarn resistance of the filaments 31 is 10^{5.5}Ω. This original yarn resistance is a resistance value per 15 mm-long piles as a bundle of 50 fibers of the filaments 33. Further, a planted fiber density of the filaments 31 of the fur brush roller 33 is 120×10³ fibers/inch². The developing sleeve (core metal) 32 is 16 min in diameter, and the fur brush roller 33 is 24 mm in outer diameter and is 0.7 mm in entering amount (penetration depth) into the photosensitive drum 1. Here, the entering amount is represented by the following distance with respect to a normal direction to the photosensitive drum 1 at a central part of a contact portion between the fur brush roller 33 and the photosensitive drum 1 with respect to the rotational direction of the photosensitive drum 1. That is, the distance is a distance between an outer peripheral (surface) position of the fur brush roller 33 and an outer peripheral (surface) position of the photosensitive drum 1 on the assumption that the fur brush roller 33 is not deformed by the photosensitive drum 1.

During a charging operation, the fur brush roller 33 is rotationally driven in an arrow R2 direction (clockwise) in the figure, i.e., so that an advancing direction of the outer peripheral surface thereof is opposite to an advancing direction of the outer peripheral surface of the photosensitive drum 1 at the contact portion with the photosensitive drum 1.

Further, during the charging operation, to the charging sleeve 32, from a charging power source 34 as a charging voltage applying means which is a power source, a DC voltage of a predetermined polarity (negative polarity in this embodiment) and a predetermined is applied as a charging bias (charging voltage). By this, electric charges are injected from the filaments 31 of the fur brush roller 33 into the photosensitive drum 1, so that the photosensitive drum 1 is charged. A contact position between the fur brush roller 33 and the photosensitive drum 1 with respect to the rotational direction of the photosensitive drum 1 is a charging part (charging nip) b.

In this embodiment, during image formation, the peripheral speed of the photosensitive drum 1 is 300 mm/sec, and the peripheral speed of the fur brush roller 33 is 1000 mm/sec. The fur brush roller 33 as rotates so that the outer peripheral surfaces of the photosensitive drum 1 and the fur brush roller 33 move in opposite directions at the charging part b, and therefore a relative speed between the fur brush roller 33 and the photosensitive drum 1 is 1300 mm/sec. Further, in this embodiment, an initial value of the charging bias applied to the charging sleeve 32 is −700 V.

The surface of the photosensitive drum 1 charged by the fur brush charger 3 is image-exposed to light by the exposure device 4. By this, on the surface of the photosensitive drum 1, an electrostatic latent image (electrostatic image corresponding to an image-exposure pattern is sequentially formed. A light irradiation position by the exposure device 4 with respect to the rotational direction of the photosensitive drum 1 is an image exposure part c.

The exposure device 4 is a laser scanner which is a digital exposure means. The laser scanner outputs laser light ON/OFF-modulated correspondingly to an image signal, thus subjecting the surface of the photosensitive drum 1 to scanning exposure to light. By this, the electrostatic latent image corresponding to the image signal (image information) is formed on the surface of the photosensitive drum 1.

Incidentally, the image exposure means may also be another digital exposure device such as an exposure device using an LED array or an exposure device using a light source and a liquid crystal shutter. Further, the image exposure means may also be an analog exposure device in which an original image is subjected to slit projection exposure by an imaging optical system.

The electrostatic latent image formed on the photosensitive drum 1 is developed as a toner image by the developing device 5. In this embodiment, the developing device 5 is a reverse-developing device using a two-component developer (admixture of a negatively chargeable toner and positively chargeable magnetic particles for development). The developing device 5 includes a developing container 51 accommodating a two-component developer 55 and a non-magnetic developing sleeve 52 as a developer carrying member. The developing sleeve 52 is provided rotatably in the developing container 51 so that a part of the outer peripheral surface thereof is exposed to an outside of the developing container 51. The developing sleeve 52 is rotationally driven at a predetermined peripheral speed in an arrow R3 direction (counterclockwise) in the figure, i.e., so that an advancing direction of the outer peripheral surface thereof is the same direction as the advancing direction of the outer peripheral surface of the photosensitive drum 1 at an opposing portion to the photosensitive drum 1. Then, on the outer peripheral surface of the developing sleeve 52, the two component developer 55 is adsorbed as a magnetic brush layer by a magnetic force of a magnet roller 53 disposed in the developing sleeve 52, and then is fed with the rotation of the developing sleeve 52. The two-component developer 55 on the developing sleeve 52 is rectified in a predetermined thin layer by a developing blade 54 as a developer layer thickness regulating member. The developing sleeve 52 is opposed to the photosensitive drum 1 with a predetermined interval, and is disposed substantially in parallel to the photosensitive drum 1. The opposing portion between the developing sleeve 52 and the photosensitive drum 1 with respect to the rotational direction of the photosensitive drum 1 is a developing part d.

Further, to the developing sleeve 52, a predetermined developing bias (developing voltage) is applied from a developing power source 56 as a developing voltage applying means. Then, the toner in the two-component developer which is coated as the thin layer on the rotating developing sleeve 52 is selectively deposited on the surface of the photosensitive drum 1 correspondingly to the electrostatic latent image by an electric field formed at the developing part d by the developing bias. By this, the electrostatic latent image is developed as a toner image. In this embodiment, the toner image is formed by a combination of the image exposure and the reversal development. That is, the toner image is formed by depositing the toner, charged to the same polarity (negative polarity in this embodiment) as the charge polarity of the photosensitive drum 1, on an exposed portion on the photosensitive drum 1 lowered in absolute value of the potential by being exposed to light after being uniformly charged.

Further, in order to maintain a toner content (concentration) of the two-component developer 55 in the developing container 51 within a predetermined approximately certain range, the toner content of the two-component developer 55 in the developing container 51 is detected by, e.g., an optical toner content sensor (not shown). Then, depending on detection information thereof, drive of a toner supplying roller in a toner hopper 58 is controlled, so that the toner t in the toner hopper 58 is supplied to the two-component developer 55 in the developing container 51. The toner supplied to the two-component developer 55 is uniformly stirred by a stirring member 57.

On the other hand, the recording material S is separated and fed one by one from a sheet feeding mechanism portion (not shown). Then, at predetermined control timing, the recording material S is introduced into a transfer nip which is a contact portion between the photosensitive drum 1 and a transfer roller 6. The contact portion (transfer nip) between the photosensitive drum 1 and the transfer roller 6 is a transfer part e.

The transfer roller 6, is constituted by an electroconductive roller. To the transfer roller 6, from a transfer power source 61 as a transfer voltage applying means, as a transfer bias (transfer voltage), a predetermined DC voltage of a predetermined potential having an opposite polarity (positive polarity in this embodiment) to a normal charge polarity of the toner forming the toner image is applied at predetermined control timing. By this, on the surface of the recording material S passing through the transfer part e, the toner image on the surface of the photosensitive drum 1 is successively is transferred electrostatically.

The recording material S passing through the transfer part e is separated from the surface of the photosensitive drum 1, and then is introduced into the fixing device 9, in which the toner image is fixed, and then the recording material S is discharged as an image-formed product to an outside of the image forming apparatus 100. The fixing device 9 is a heat fixing apparatus (device) including a press-contact roller pair constituted by a heater 91 which is heated to and temperature-controlled at a predetermined fixing temperature, and an elastic pressing roller 92.

Further, the surface of the photosensitive drum 1 after the recording material S is separated therefrom is subjected to removal of a residual deposited matter such as a transfer residual toner by the cleaning device 7, and then is repetitively subjected to image formation. In this embodiment, the cleaning device 7 is a blade cleaning device including a 2 mm-thick methane-made cleaning blade 71 as a cleaning member. The cleaning blade 71 is contacted to the photosensitive drum 1 in a counter direction against the photosensitive drum 1. A contact portion between the cleaning blade 71 and the photosensitive drum 1 with respect to the rotational direction of the photosensitive drum 1 is a cleaning part f. The photosensitive drum 1 is cleaned by scraping off the transfer residual toner or the like from the surface thereof by this cleaning blade 71. The transfer residual toner or the like scraped off from the surface of the photosensitive drum 1 is accommodated in a cleaning container 72.

### 2. Deterioration of Fur Brush Roller and Image Quality

A relationship between an image output sheet number and an image quality when an image output durability test was conducted using the image forming apparatus 100 in this embodiment in this embodiment was evaluated.

The influence of deterioration of the fur brush roller 33 as the charging brush on the image quality is particularly conspicuous in a halftone image, and therefore graininess of the halftone image was evaluated as an index of the image quality.

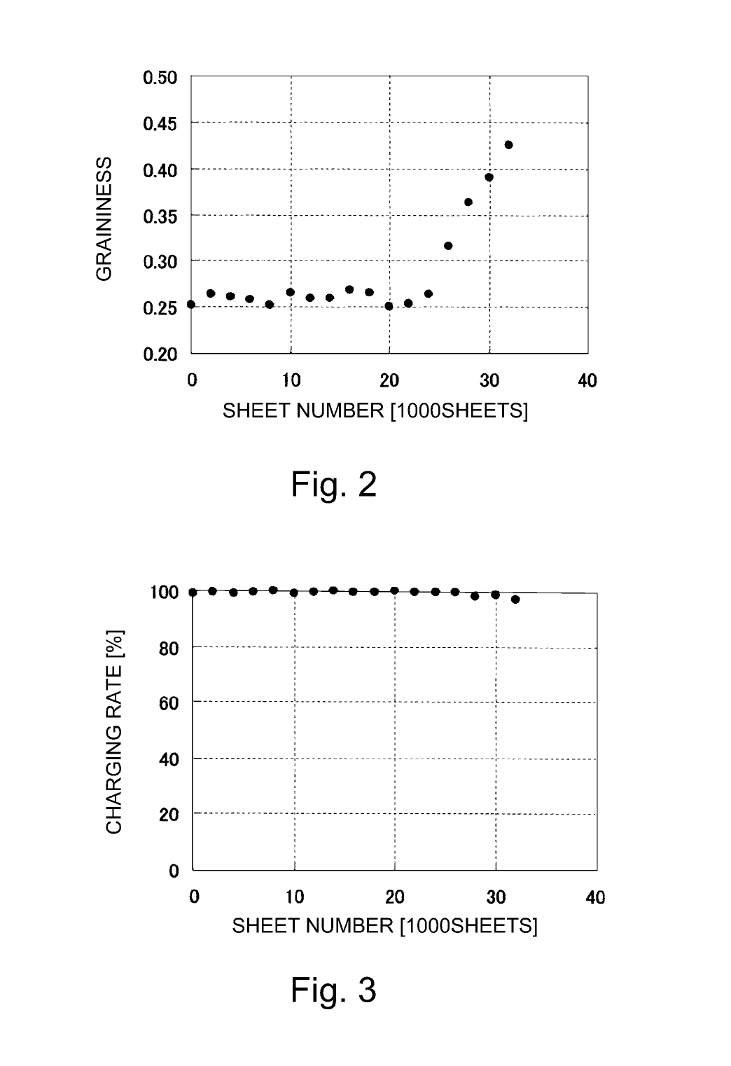

FIG. 2 shows a relationship between the image output sheet number and the graininess. From FIG. 2, it is understood that the graininess abruptly worsens after the image output sheet number reaches about 24,000 sheets.

Incidentally, as the toner, the black toner in which a change in graininess is most conspicuous was used. Further, the graininess was measured using Wiener spectrum which is a power spectrum for density fluctuation. A value obtained by multiplying the Wiener spectrum by a visual spatial frequency characteristic (Visual Transfer Function: VTF) and then by integrating the multiplied value is graininess (GS). A larger value of GS shows that the graininess is worse. The GS value is shown in a formula 1.

GS=exp(−1.8 D̅)∫\sqrt{WS(u)}·VTF(u)du (1)

Here, u is a spatial frequency, WS(u) is a transfer function of the Wiener spectrum, and VTF(u) is a transfer function of the visual spatial frequency. Further, the term of:
exp(−1.8 D̅)
   is a function using an average density (content):
D̅
   for correcting a difference between the density and human-perceivable brightness.

### 3. Charging Rate

Next, a relationship between the image output sheet number and a charging rate when the image output durability test was conducted using the image forming apparatus 100 in this embodiment was evaluated.

The contact is a proportion of a charge potential of the photosensitive drum 1 to the charging bias applied to the charging sleeve 32. The charge potential was obtained by averaging an output value of a potential sensor 8 during the application of the charging bias through ½ of full circumference of the photosensitive drum 1. The potential sensor 8 as a surface potential detecting means measures the surface potential of the photosensitive drum 1 between the image exposure part c and the developing part d. An opposing portion between a detecting portion of the potential sensor 8 and the photosensitive drum 1 with respect to the rotational direction of the photosensitive drum 1 is a potential detecting part g.

FIG. 3 shows the relationship between the image output sheet number and the charging rate. From FIG. 3, it is understood that the charging rate is substantially constant even when the image output sheet number reaches 320,000 sheets.

### 4. Graininess and Charging Rate

As described above, by the increase in image output sheet number, the graininess gradually worsened, but the charging rate did not lower. The reason therefor would be considered as follows.

When the use amount of the fur brush roller 33 increases, by contamination of the filaments 31 with or abrasion (wearing) of the filaments 31 by the deposited matter such as the toner or the external additive for the toner, the number of the filaments 31 incapable of injecting the electric charges increases. Further, although the number of the filaments 31 is small, the filaments 31 fall out of the fur brush roller 33. That is, by the increase in use amount, a region of the fur brush roller 33 where the injection charging cannot be effected partly increases.

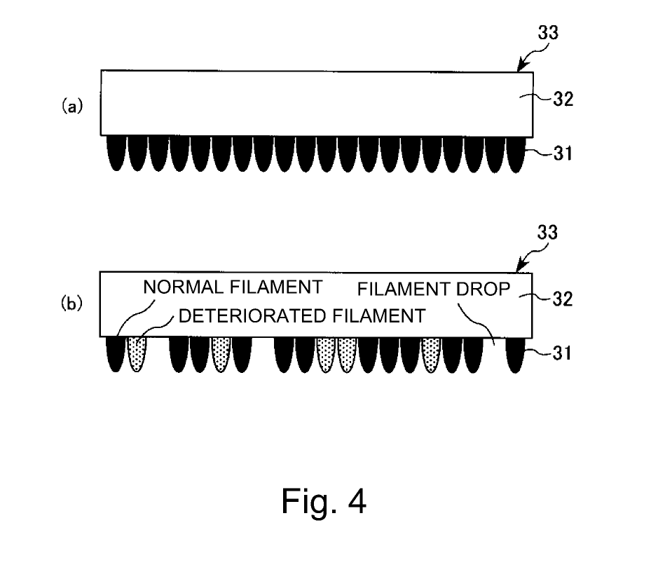

FIG. 4 schematically shows states of the filaments 31 of the fur brush roller 33 in an initial stage of use and during deterioration (such as end of a lifetime) (in a cross-section cut along a rotational axis direction of the photosensitive drum 1). In FIG. 4, (a) shows the state in the initial stage of use, and (b) shows the state during the deterioration.

Here, the number of the filaments 31, contacting the photosensitive drum 1, per unit length of the photosensitive drum 1 with respect to a longitudinal direction (rotational axis direction) of the photosensitive drum 1 during passing of the filaments 31 through the charging nip b is called a “contact frequency” of the filaments 31.

During the deterioration, as shown in (b) of FIG. 4, the planted fiber density of the filaments 31 capable of injecting the electric charges lowers, and therefore the contact frequency of the filaments 31 capable of injecting the electric charges decreases. When the contact frequency of the filaments 31 capable of injecting the electric charges is decreased by the increase in use amount of the fur brush roller 33, an uncharged region of the surface of the photosensitive drum 1 increases, so that minute potential non-uniformity becomes large. That is, it would be considered that the decrease in contact frequency of the filaments 31 capable of injecting the electric charges is a factor of deterioration in graininess.

In order to verify whether or not the decrease in contact frequency of the filaments 31 capable of injecting the electric charges can constitute the factor of the image deterioration, the contact frequency of the filaments 31 capable of injecting the electric charges was controlled, and then a relationship between the contact frequency and the graininess was checked.

Here, the contact frequency of the filaments 31 is proportional to the product of the planted fiber density and a relative speed between the fur brush roller 33 and the photosensitive drum 1.

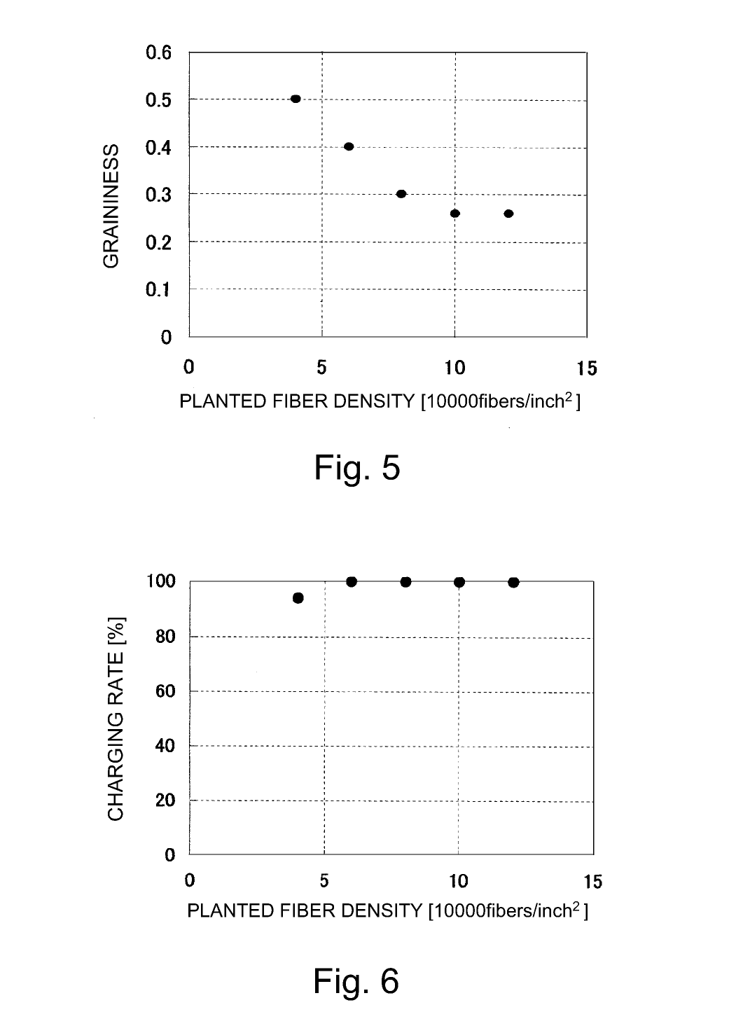

Therefore, the contact frequency of the filaments 31 capable of injecting the electric charges was controlled by changing the planted fiber density of the fur brush roller 33, and the relationship with the graininess at that time was checked. Further, at the same time, also evaluation of the charging rate was made. Results are shown in FIGS. 5 and 6.

From FIG. 5, when the planted fiber density is 80,000 fibers/inch² or less, the graininess worsens with a lower planted fiber density. That is, when the contact frequency of the filaments 31 capable of injecting the electric charges is a certain number or less, it is understood that the graininess worsens with a lower contact frequency.

On the other hand, from FIG. 6, it is understood that when the planted fiber density is 40,000 fibers/inch², the charging rate somewhat lowers, but when the planted fiber density is 60,000 fibers/inch² or more, the charging rate becomes substantially 100%. That is, the brush having the planted fiber density of 60,000 fibers/inch² shows a characteristic such that the graininess worsens similarly as in, the brush during the deterioration, but the charging rate remains unchanged.

From this result, it can be said that thinking such that the factor of the graininess deterioration due to the increase in use amount of the fur brush roller 33 is the decrease in contact frequency of the filaments 31 capable of injecting the electric charges is appropriate.

Further, the reason why the charging rate little lowers even when the contact frequency of the filaments 31 capable of injecting the electric charges decreases to some extent would be considered as follows.

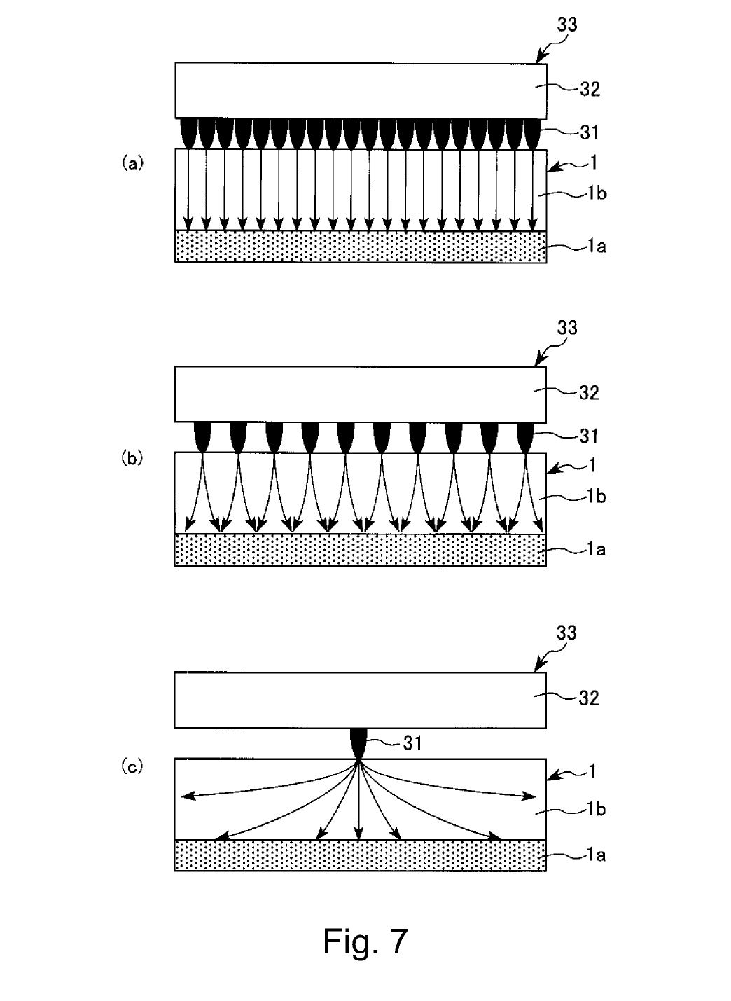

FIG. 7 schematically shows cross-sections of contact portions each between the photosensitive drum 1 and the brush roller 33 (cross-sections each cut along the rotational axis direction of the photosensitive drum 1). In FIG. 7, the photosensitive drum 1 is shown in a simplified manner such that the photosensitive drum 1 includes the electroconductive substrate (aluminum support) 1a and the functional layer (photosensitive layer) 1b thereon.

In the case where the contact frequency of the filaments 31 capable of injecting the electric charges is sufficient, as shown in (a) of FIG. 7, the electric charges uniformly distribute over the surface of the photosensitive drum 1, and electric lines of force are perpendicular to the electroconductive substrate 1a of the photosensitive drum 1.

When the contact frequency of the filaments 31 capable of injecting the electric charges gradually lowers, as shown in (b) and (c) of FIG. 7, the electric lines of force gradually broaden. For that reason, the number of the electric lines of force per one of contact portions (injection points) increases. The number of the electric lines of force is proportional to an electric charge amount, and therefore it is understood that when the contact frequency lowers, a charged electric charge amount per one point increases.

That is, when a charging area (contact frequency) lowers as shown in (b) of FIG. 7, the charged electric charge amount per one point increases, and therefore it would be considered that a total electric charge amount corresponding to the charging rate remains unchanged. However, the electric charges do not exist uniformly, and therefore it would be considered that the minute surface potential non-uniformity of the photosensitive drum 1 becomes large.

From the above consideration, a phenomenon when the fur brush roller 33 deteriorates by the increase in use amount is summarized as follows. That is, by the increase in use amount of the fur brush roller 33, the contact frequency of the filaments 31 capable of injecting the electric charges decreases, and thus the graininess worsens, but the electric charge amount per injection point increases by the broadening of the electric lines of force, so that the charging rate does not lower.

### 5. Potential Non-Uniformity Index

As described above, the factor of the image deterioration due to the deterioration of the fur brush roller 33 would be considered as the minute potential non-uniformity of the photosensitive drum 1.

From a potential smoothing effect or the like by the exposure process, the influence of the fluctuation of the charge potential of the photosensitive drum 1 on the image quality starts from after the potential fluctuation becomes a certain magnitude or more. Accordingly, even if the minute potential non uniformity of the photosensitive drum 1 can be measured with high accuracy, the fur brush roller 33 can be exchanged before the potential non-uniformity adversely affects the image quality.

However, the minute potential non-uniformity of the photosensitive drum 1 exceeds a spatial resolution, of the potential sensor, actually for the image forming apparatus, and therefore even when the surface potential of the photosensitive drum 1 after the charging is measured by the potential sensor, it is difficult to directly detect the potential non-uniformity.

However, when the surface electric charges after the charging of the photosensitive drum 1 are removed by the fur brush roller 33 without being removed by pre-exposure and the charging rate/charge removing rate are obtained, it is possible to detect the magnitude of the minute potential non-uniformity of the photosensitive drum 1 depending on the magnitude thereof.

Here, a bias (charging bias) applied to the to fur brush roller 33 when the photosensitive drum 1 is charged is Vb1, and a bias (charge-removing bias) applied to the fur brush roller 33 when the photosensitive drum 1 is charge-removed is Vb2. Further, a surface potential (pre-exposure potential) of the photosensitive drum 1 before the charging is Vd0, a surface potential (charged potential) of the photosensitive drum 1 after the charging is Vd1, and a surface potential (charge-removed potential) of the photosensitive drum 1 after the charge removal is Vd2. At this time, the charging rate, the charge-removing rate and the potential non-uniformity index can be represented by the following formulas.

Charging rate(%)=|Vd1−Vd0|/|Vb1−VdC|×100 (1)

Charge-removing rate(%)=|Vd2−Vd1|/|Vb2̂Vd1|×100 (2)

Potential non-uniformity index=(Charging rate)/(Charge-removing rate) (3)

The potential non-uniformity index becomes larger with a larger minute potential non-uniformity of the photosensitive drum 1. The reason therefor will be described.

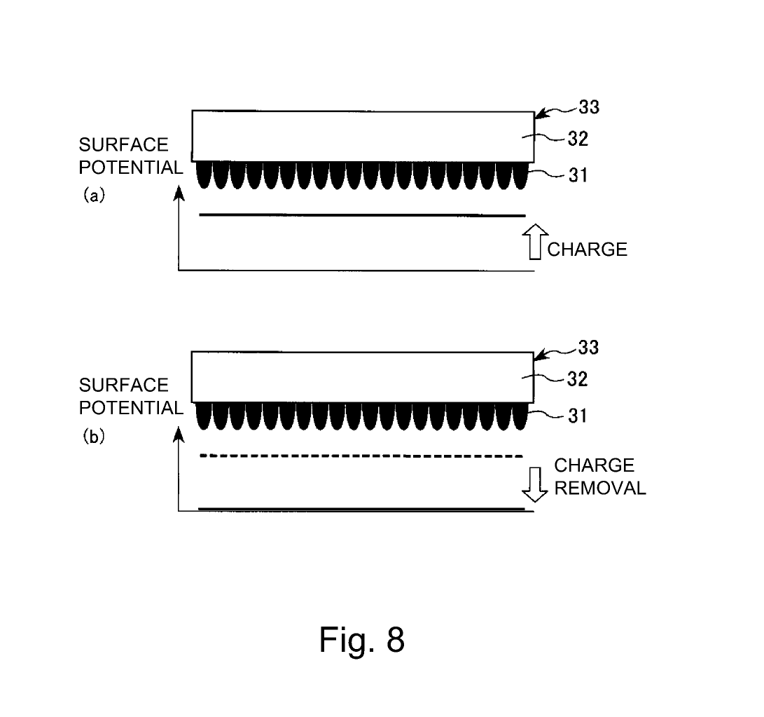

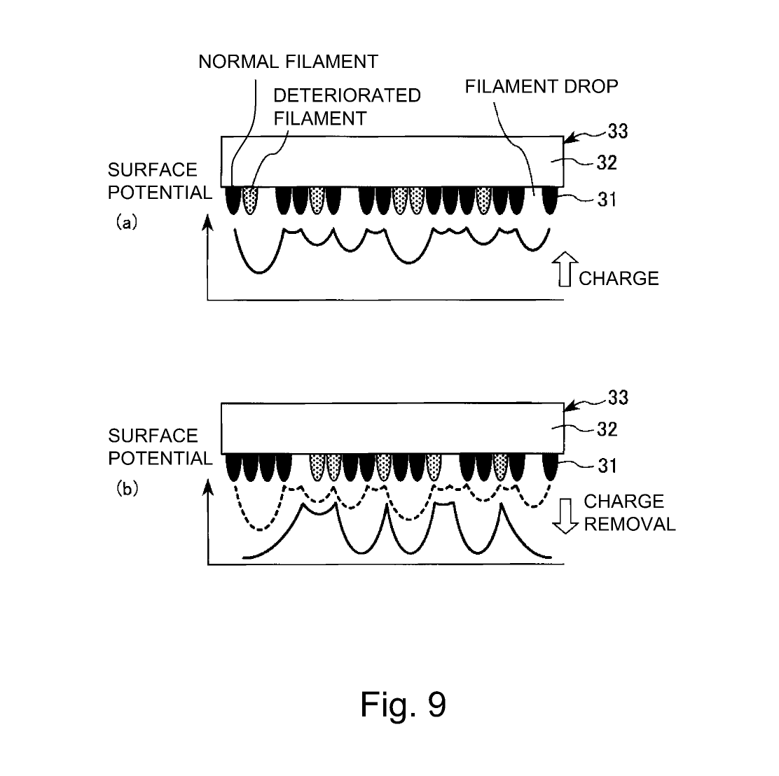

Each of FIG. 8 and FIG. 9 schematically shows a state (cross-section cut along the rotational axis direction of the photosensitive drum 1) of the filaments 31 of the fur brush roller 33 in an initial stage of use and after the use, and a state of the surface potential of the photosensitive drum 1 charged/charge-removed by the fur brush roller 33.

With respect to the fur brush roller 33 in the initial stage of use, the contact frequency of the filaments 31 capable of injecting the electric charges is sufficiently ensured so as not to cause the minute potential non-uniformity of the photosensitive drum 1. For that reason, as shown in (a) of FIG. 8, the surface of the photosensitive drum 1 after the charging is electrically charged uniformly. Further, the contact frequency is sufficient, and therefore as shown in (b) of FIG. 8, almost all the electric charges imparted by the charging can be removed.

On the other hand, when the use amount of the fur brush roller 33 increases, as described above, the increase in the number of the filaments 31 incapable of injecting the electric charges and drop of the filaments 31 generate due to the contamination and the abrasion. For that reason, the contact frequency of the filaments 31 capable of injecting the electric charges decreases, so that the region where the injection charging cannot be made partly increases. For that reason, as shown in (a) of FIG. 9, the surface potential of the photosensitive drum 1 after the charging has many minute potential non-uniformity portions. Further, the charging rate at this time little changes from the initial stage of use for the reason described above, and therefore an output of the potential sensor is not distinguished from that in the state of the initial stage of use. When such a photosensitive drum 1 in which the many minute potential non uniformity portions exist is charge-removed, the electric charges at the surface of the photosensitive drum 1 cannot be removed in a place where the filaments 31 deteriorate of a place where the filaments 31 drop off. For that reason, the surface potential of the photosensitive drum 1 cannot be lowered to the charge-removing bias.

That is, as shown in (b) of FIG. 4, when the contact frequency of the filaments 31 capable of injecting the electric charges lowers due to the increase in use amount of the fur brush roller 33 as shown in (b) of FIG. 4, charging power is maintained, but power for removing the potential after the charging lowers. Accordingly, when the contact frequency of the filaments 31 capable of injecting the electric charges lowers and the minute potential non-uniformity of the photosensitive drum 1 becomes large, the charging rate remains unchanged, but the charge-removing rate lowers. For that reason, when (charging rate)/(charge-removing rate)=potential non-uniformity index holds, the potential non-uniformity index increases. If the photosensitive drum 1 can be substantially completely charged uniformly, the charging rate and the charge-removing rate are equal to each other, and therefore the potential non-uniformity index is 1.

### 6. Evaluation Sequence

One of objects of this embodiment is to evaluate the minute potential non-uniformity due to the deterioration of the charging brush to appropriately detect the time of exchange of the charging brush and to maintain the image quality at a good level for a long term.

For that purpose, the image forming apparatus 100 in this embodiment executes, at predetermined timing, an evaluation sequence for evaluating the deterioration of the fur brush roller 33 as the charging brush.

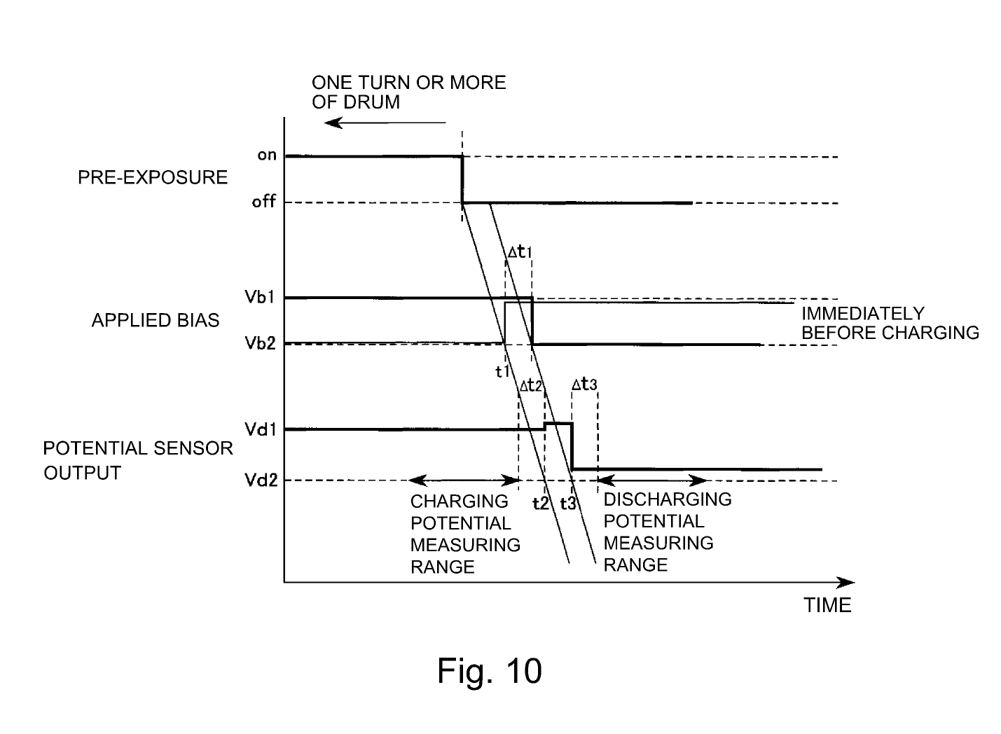

FIG. 10 shows the evaluation sequence for obtaining the potential non-uniformity index in this embodiment. This evaluation sequence will be described.

First, in a state in which the pre-exposure lamp 2 is turned on, the charging bias Vb1 as a first voltage is applied to the developing sleeve 32 of the charging brush. At this time, the surface potential of the photosensitive drum 1 immediately in front of the charging part b is substantially 0 V in this embodiment since the pre-exposure lamp 2 is turned on. That is, pre-charging potential Vd0=0 holds.

Here, with respect to the photosensitive drum 1 on which the surface potential is not 0 V even when the pre-exposure lamp 2 is turned on, the pre-charging potential Vd0 can be obtained in the following manner. That is, the surface potential of the photosensitive drum 1 when the fur brush roller 33 is placed in a float state by turning on the pre-exposure lamp 2 and by turning off the bias applied to the charging sleeve 32 immediately before this sequence is Vd0.

In this embodiment, Vd0=0 always holds, and therefore there is no need to measure the pre-charging potential Vd0.

In a state in which the pre-exposure lamp 2 is turned on and the charging bias Vb1 is applied to the charging sleeve 32, the surface of the photosensitive drum 1 is charged through one full circumference or more, and thereafter the pre-exposure lamp is turned off.

Then, a time when a position of the surface of the photosensitive drum 1 which was disposed at the charge-removing part a (immediately below the pre-exposure lamp 2) when the pre-exposure lamp 2 is turned off reaches the charging part b (immediately under the fur brush roller 33) is t1. In this case, after Δt₁ sec front t1, the bias applied to the charging sleeve 32 is switched to the charge-removing bias Vb2 as a second voltage. The surface potential of the photosensitive drum 1 immediately in front of the charging part b is in a state in which the electric charges provided by the injection charging are not removed.

A time when the position of the surface of the photosensitive drum 1 which was disposed at the charge-removing part a (immediately below the pre-exposure lamp 2) when the pro-exposure lamp 2 is turned off reaches the potential detecting part g (immediately below the potential sensor 8) is t2. In this case, a margin of Δt₂ is ensured (subtracted) from the time t2 with respect to a negative direction, and an average of the surface potential for the time when the photosensitive drum 1 rotates through ½ of full circumference is taken as the charging potential Vd1 as a first potential.

A time when the position of the surface of the photosensitive drum 1 which was disposed at the charging part b (immediately under the fur brush roller 22) when the bias applied to the charging sleeve 32 is changed to the charge-removing bias Vb2 reaches the potential detecting part g (immediately below the potential sensor 8) is t3. In this case, a margin of Δt₂ is ensured (subtracted) from the time t3 with respect to a positive direction, and an average of the surface potential for the time when the photosensitive drum 1 rotates through ½ of full circumference is taken as the charge-removing potential Vd2 as a second potential.

The charging rate, the charge-removing rate and the potential non-uniformity index are defined by the above-mentioned formulas (1), (2) and (3), respectively. Further, Δt₁, Δt₂ and Δt₃ may be the same value or different values. In this embodiment, Δt₁=Δt₂=Δt₃=0.1 sec was set. Further, in this so embodiment, the charging bias Vb1 was −600 V, and the charge-removing bias Vb2 was −100 V.

Here, the charging bias Vb1 may be the same value as or a different value from the charging bias applied to the charging sleeve 32 during the image formation. From the viewpoint of suppression of a measurement error, it is desirable that a potential difference between the charging potential and the charge-removing potential is 300 V or more. Further, from the viewpoint of suppression of damage on the photosensitive drum 1 and the fur brush roller 33, an absolute value of the charging potential may desirably be 700 V or less. For that reason, the charging bias Vb1 may preferably be set at, e.g., −600 V as in this embodiment (e.g., −300 V to −700 V), and the charge-removing bias Vb2 may preferably be set at, e.g., −100 V (e.g., 0 V to −400 V).

Further, in this embodiment, the potential sensor 8 detects the surface potential of the photosensitive drum 1 at a substantially central position of the photosensitive drum 1 with respect to the rotational axis direction. This position can be appropriately changed, but a problem is such a point that the brush is contaminated in an image region, and therefore the potential sensor 8 may preferably be disposed within an image forming region on the photosensitive drum 1.

Incidentally, in this embodiment, the peripheral speed of the photosensitive drum during the evaluation sequence and the peripheral speed of the fur brush roller 33 during the evaluation sequence are the same as those described above during the image formation.

The potential non-uniformity index is best at 1, and shows that the potential non uniformity worsens with an increasing value from 1.

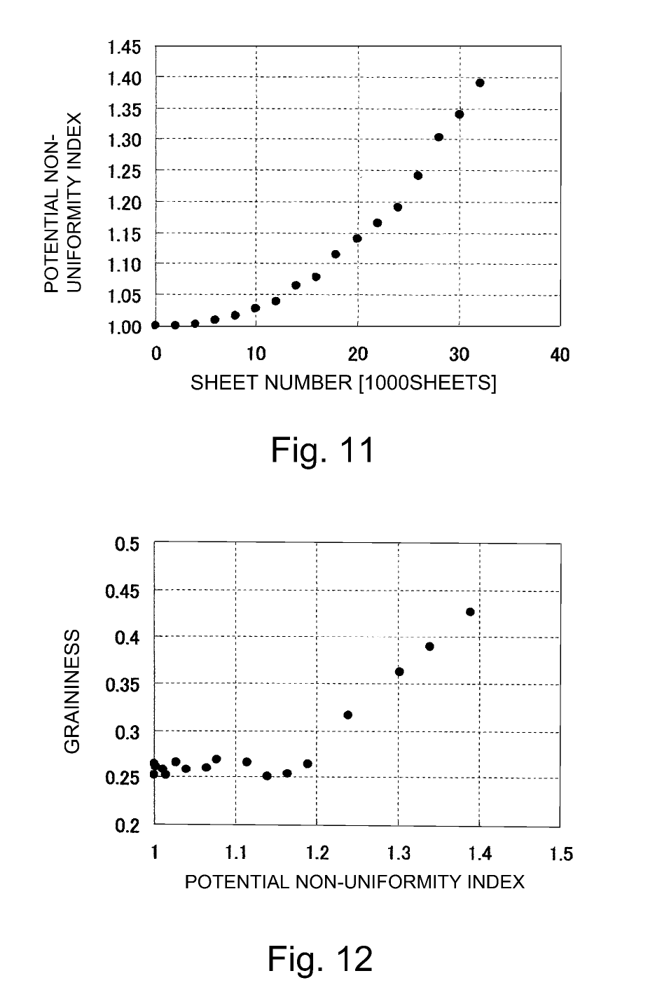

Here, in order to obtain the potential non-uniformity index which is an index of the exchange of the fur brush roller 33 in the image forming apparatus 100 in this embodiment, the above-described evaluation sequence was performed every 2,000 sheets of the image output sheet number, and a relationship between the image output sheet number and the potential non-uniformity index was checked. A result is shown in FIG. 11. From FIG. 11, it is understood that the potential non-uniformity index increases with the increase in image output sheet number.

Further, simultaneously with the potential non-uniformity index, also evaluation of graininess was made, so that a relationship between the potential non-uniformity index and the graininess was obtained. A result is shown in FIG. 12. From FIG. 12, it is understood that the graininess starts deterioration when the potential non-uniformity index exceeds 1.15.

Accordingly, in the image forming apparatus 100 in this embodiment, the fur brush roller 33 is exchanged when the potential non-uniformity index increases up to 1.15, whereby the fur brush roller 33 can be exchanged before the image quality lowers, and the image quality can be maintained at a good level.

For that reason, in this embodiment, in the case where the evaluation sequence is executed and the potential non-uniformity index exceeds 1.15, a signal (exchange signal) for notifying an operator of the image forming apparatus 100 of a massage or the like for urging the operator to exchange the fur brush roller 33 is to be outputted by a notifying means (exchange notification control)

### 7. Control Method

Here, the evaluation sequence can be executed at a time of non-image formation. As the time of the non-image formation, it is possible to cite the following. There are a time of power-on (power actuation) and a time of a pre-multi-rotation operation, in which a predetermined preparatory operation for rising or the like of a fixing temperature, such as during restoration from a sleep mode is executed. Further, there is a time of a pre-rotation operation in which a predetermined preparatory operation is executed from input of an image forming signal until the image depending on image information is actually written out. Further, there is a time of a sheet (paper) interval corresponding to an interval between a recording material and a subsequent recording material during continuous image formation. Further, there is a time of a post-rotation operation in which a predetermined processing operation (preparatory operation) is executed after the image formation is ended. In this embodiment, as the time of non-image formation, at the time of the post-rotation or the time of the sheet interval, the evaluation sequence is executed every predetermined image output sheet number.

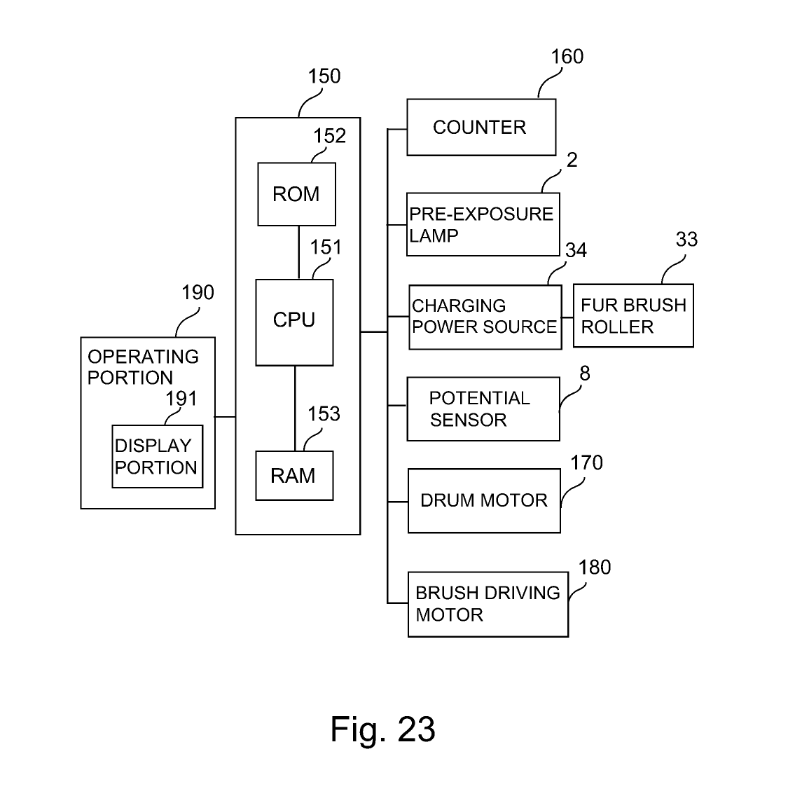

FIG. 23 shows a schematic control mode of a principal portion of the image forming apparatus 100 in this embodiment. The operation of the image forming apparatus 100 is subjected to centralized control by CPU 151 as a control means provided in a control circuit 150 provided in the image forming apparatus 100. The CPU 151 controls operations of the respective portions in accordance with programs and data which are stored in ROM 152 as a storing means and which are read out from ROM 152 and stored in RAM 153 as desired.

For example, from a relationship with this embodiment, the CPU 151 reads image output sheet number information integrated every image output in a counter (storing device) 160 as an image output sheet number counting means, and uses the read information for discrimination as to whether or not the evaluation sequence should be executed. Further, as an executing portion, the CPU 151 controls ON/OFF of the pre-exposure lamp 2, ON/OFF of biases (charging bias, charge-removing bias) applied from the charging power source 34 to the fur brush charger 3 (fur brush roller 33), output values, and the like. Further, as the executing portion, the CPU 151 rends the output of the potential sensor 8 in the evaluation sequence, and then uses the output, together with an output set value of the charging power source 34, for calculating the potential non-uniformity index.

Further, the CPU 151 outputs signals, for effecting predetermined display, to a display portion 191 as a notifying portion provided at an operating portion 190 provided in the image forming apparatus 100 and to a display portion (not shown) as a notifying portion provided on an external device (personal computer or the like) communicably connected with the image forming apparatus 100.

In addition, as a controller, the CPU 151 effects ON/OFF of a drum motor 170 as a driving means for the photosensitive drum 1 and of a brush driving motor 180 as a driving means for the fur brush roller 33, and control of a driving speed or the like.

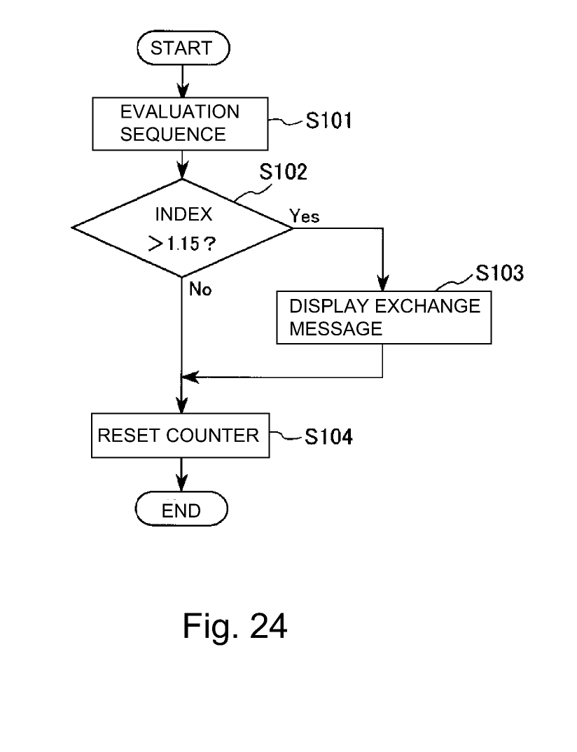

FIG. 24 is a flowchart showing a procedure of the exchange notification control of the fur brush roller 33 in this embodiment.

First, the CPU 151 as the executing portion executes the evaluation sequence and obtains the potential non-uniformity index as the function of the calculating portion (S101). This evaluation sequence is executed at the time of the post-rotation or the time of the sheet interval every time when the number of counts of the image output sheet number by the counter 160 reaches 2,000 sheets.

Next, the CPU 151 discriminates whether or not the potential non-uniformity index obtained in the evaluation sequence exceeds 1.15 which is a threshold, for discriminating the exchange of the fur brush roller 33, stored in the ROM 152 in advance (S102).

In S102, the CPU 151 discriminates that the potential non-uniformity index exceeds 1.15, the CPU 151 causes the display 191 as the notifying portion of the operating portion 190 to display the massage for urging the operator to exchange the fur brush roller 33 (S103). Thereafter, the number of counts by the counter 160 is reset to 0 (S104), so that the exchange notification control of the fur brush roller 33 is ended.

IN S102, in the case where the CPU 151 discriminates that the potential non-uniformity index is 1.15 or less, the CPU 151 resets the number of counts by the counter to 0 (S104), and ends the exchange notification control of the fur brush roller 33.

### 8. Effect

In order to confirm an effect of this embodiment, a verification experiment was conducted.

First, an image output durability test up to 100,000 sheets was conducted, and whether or not graininess was maintained was verified. The potential non-uniformity index was obtained by performing the evaluation sequence every 2,000 sheets of the image output sheet number. Further, also the graininess was evaluated every 2,000 sheets of the image output sheet number. Further, an exchanging condition of the fur brush roller 33 was the time when the potential non-uniformity index exceeded 1.15.

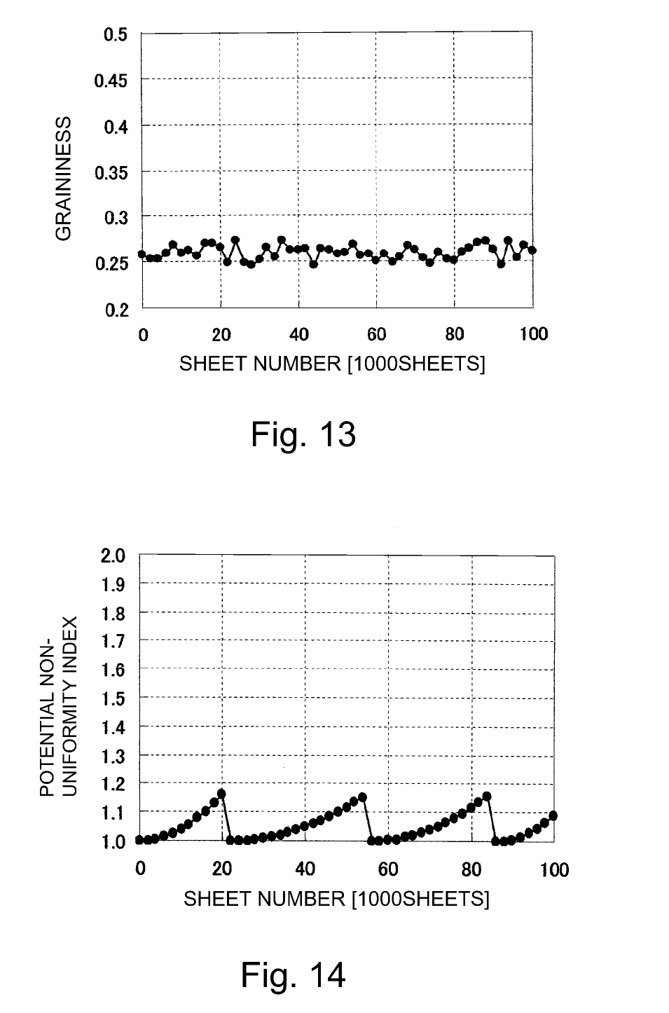

FIG. 13 shows a relationship between the image output sheet number and the graininess. From FIG. 13, it is understood that the graininess is always 3.0 or less and is kept in a good state.

FIG. 14 shows a relationship between the image output sheet number and the potential non-uniformity index. During the image output durability test of 100,000 sheets, the exchange of the fur brush roller 33 is made three times.

Next, the image output durability test was conducted again using the fur brush roller 33 after the exchange, and the graininess at that time was evaluated, so that whether or not the exchange was made at appropriate timing, i.e., whether or not the exchange timing was excessively early was verified. In this case, with respect to three fur brush roller 33 after the exchange, the graininess was evaluated every 1,000 sheets of the image output sheet number.

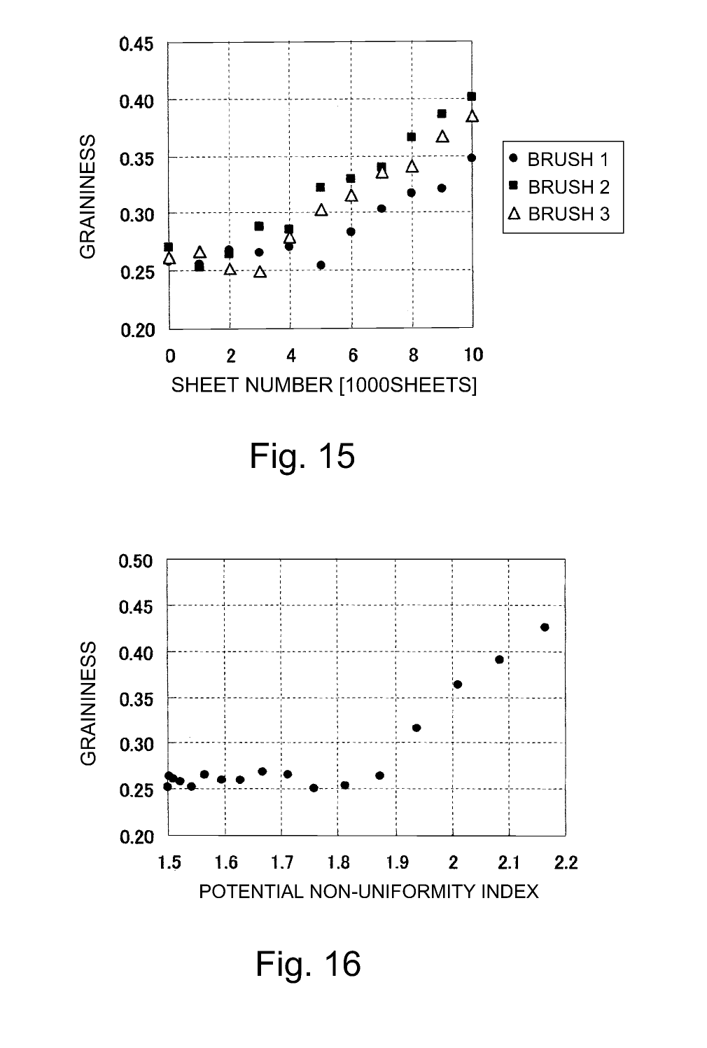

FIG. 15 shows a relationship between the image output sheet number and the graininess. From FIG. 15, it is understood that with respect to any of the brushes, the graininess starts deterioration within 4,000 to 6,000 sheets. It is possible evaluate that the exchange timing is appropriate.

In this way, in this embodiment, the image forming apparatus 100 includes the rotatable photosensitive member 1, the fur brush roller 33 for injecting the electric charges into the surface of the photosensitive member by being supplied with the voltage in contact with the surface of the photosensitive member 1, and the potential sensor as a detecting means 8 for detecting the surface potential of the photosensitive member 1. Further, the image forming apparatus 300 includes a calculating means as a calculating portion for making the following calculation on the basis of a detection result of the detecting means 8. That is, the calculating means obtains information (charging rate in this embodiment) on the charging proportion which is the proportion of the surface potential of the photosensitive member 1, charged by application of the voltage to the charging brush 33, to the voltage applied to the charging brush 33 when the photosensitive member 1 is charged by the charging brush 33. Further, the calculating means obtains information (charge-removing rate in this embodiment) on the charge-removing proportion which is the proportion of the surface potential of the photosensitive member 1, charge removed by the application of the voltage to the charging brush 33, to the voltage applied to the charging brush 33 when the photosensitive member 1 charged by the charging brush 33 is charge-removed by the charging brush 33. Further, the calculating means obtains information (potential non-uniformity index in this embodiment) on a ratio between the above-described charging proportion and the above-described charge-removing proportion. Further, the image forming apparatus 100 includes a discriminating means for discriminating the exchange timing on the basis of the information on the ratio described above. In this embodiment, the CPU 151 has the functions of the calculating means and the discriminating means.

Particularly, in this embodiment, the discriminating means outputs the signal for urging the operator to exchange the charging brush 33 in the case where the obtained ratio described above exceeds the threshold. Specifically, the calculating means calculates the ratio in the following manner. That is, the surface of the photosensitive drum 1 having the surface potential Vd0 is charged by applying a voltage having a DC component Vb1 to the charging brush 33, so that the surface potential of the charged photosensitive drum 1 is Vd1. Further, the surface of the photosensitive drum 2 having the surface potential Vd1 is charge-removed by applying a voltage having a DC component Vb2 to the charging brush 33, so that the surface potential of the charge-removed photosensitive drum 1 is Vd2. At this time, the calculating means obtains, as the information on the above-described ratio, a ratio between |Vd1−Vd0|/|Vb1−Vd0| as the information on the charging proportion and |Vd2−Vd1|/|Vb2−Vd1| as the information on the charge-removing proportion. Incidentally, the information on the charging proportion, the information on the charge-removing and the information on the ratio may be the ratio as results themselves of division as described above or corresponding amounts derived by, e.g., converting the ratios into percentages or subjecting the ratios to necessary correction.

As described above, according to this embodiment, by evaluating the minute potential non-uniformity of the photosensitive drum 1 due to the deterioration of the fur brush roller 33, it is possible to properly detect the exchange timing of the fur brush roller 33 and to maintain the image quality at a good level for a long term.

### Embodiment 2

Next, another embodiment of the present invention will be described. Basic constitution and operation of an image forming apparatus in this embodiment are the same as those of the image forming apparatus in Embodiment 1. Accordingly, elements having functions and constitutions which are identical or corresponding to those for the image forming apparatus in Embodiment 1 are represented by the same reference numerals or symbols and will be omitted from detailed description.

### 1. Outline

As described above, the potential non-uniformity index represents the magnitude of the minute potential non-uniformity of the photosensitive drum 1, and the minute potential non-uniformity depends on the contact frequency of the filaments 31 capable of injecting the electric charges. Further, the contact frequency of the filaments 31 capable of injecting the electric charges is proportional to the product of the relative speed between the fur brush roller 33 and the photosensitive drum 1 and the planted fiber density of the filaments 31 capable of injecting the electric charges. For that reason, by lowering the relative speed between the fur brush roller 33 and the photosensitive drum 1, the contact frequency of the filaments 31 capable of injecting the electric charges can be lowered. That is, even at the same planted fiber density, when the relative speed is made small, the contact frequency of the filaments 31 capable of injecting the electric charges is lowered, and therefore the potential non-uniformity index becomes large.

Accordingly, a change in potential non-uniformity index relative to the contact frequency of the filaments 31 capable of injecting the electric charges becomes large, so that it is possible to enhance sensitivity of the detection of the deterioration of the fur brush roller 33.

In this embodiment, when the evaluation sequence of FIG. 10 is performed, the fur brush roller 33 is rotationally driven at the peripheral speed of 100 mm/sec so that advancing direction of the outer peripheral surface thereof is an opposite direction to the advancing direction of the outer peripheral surface of the photosensitive drum 1 at the contact portion with the photosensitive drum 1. That is, the peripheral speed of the fur brush roller 33 is reduced than during the image formation. The peripheral speed of the photosensitive drum 1 is 300 nm/sec, and therefore the relative speed between the fur brush roller 33 and the photosensitive drum 1 is 400 mm/sec.

In this way, in this embodiment, the relative speed the photosensitive drum 1 and the charging brush 33 when the surface potential of the photosensitive drum 1 is detected in order to obtain the charging proportion, the charge-removing proportion and the ratio therebetween is smaller than that during the image formation.

In order to check the relationship between the potential non-uniformity index and the graininess under this condition, the evaluation sequence was performed every 2,000 sheets of the image output sheet number, and at the same time, evaluation of the graininess was made.

A result is shown in FIG. 16. From FIG. 16, it is understood that the graininess starts deterioration when the potential non-uniformity index exceeds 1.95.

Accordingly, in the image forming apparatus 100 in this embodiment, the fur brush roller 33 is exchanged when the potential non-uniformity index increases up to 1.95, whereby the fur brush roller 33 can be exchanged before the image quality lowers, and the image quality can be maintained at a good level.

For that reason, in this embodiment, in the case where the evaluation sequence is executed and the potential non-uniformity index exceeds 1.95, a signal (exchange signal) for notifying an operator of the image forming apparatus 100 of a massage or the like for urging the operator to exchange the fur brush roller 33 is to be outputted (exchange notification control).

### 2. Control Method

In this embodiment, similarly as in Embodiment 1, the evaluation sequence is performed during the non-image formation every time when the image output sheet number reaches the predetermined number (2,000 sheets).

The control mode of the image forming apparatus 100 in this embodiment is similar to that in Embodiment 1 shown in FIG. 23. In this embodiment, particularly, the CPU 151 as the controller controls the brush driving motor 180 during the execution of the evaluation sequence, so that the peripheral speed of the peripheral speed of the fur brush roller 33 is made slower than that during the image formation.

Further, the procedure of the exchange notification control of the fur brush roller 33 in this embodiment is similar to that in Embodiment 1 shown in FIG. 24. However, in this embodiment, the threshold used in S102 for discriminating the exchange of the fur brush roller 33 is 1.95.

### 9. Effect

In order to confirm an effect of this embodiment, a verification experiment was conducted.

First, an image output durability test up to 100,000 sheets was conducted, and whether or not graininess was maintained was verified. The potential non-uniformity index was obtained by performing the evaluation sequence every 2,000 sheets of the image output sheet number. Further, also the graininess was evaluated every 2,000 sheets of the image output sheet number. Further, an exchanging condition of the fur brush roller 33 was the time when the potential non-uniformity index exceeded 1.95.

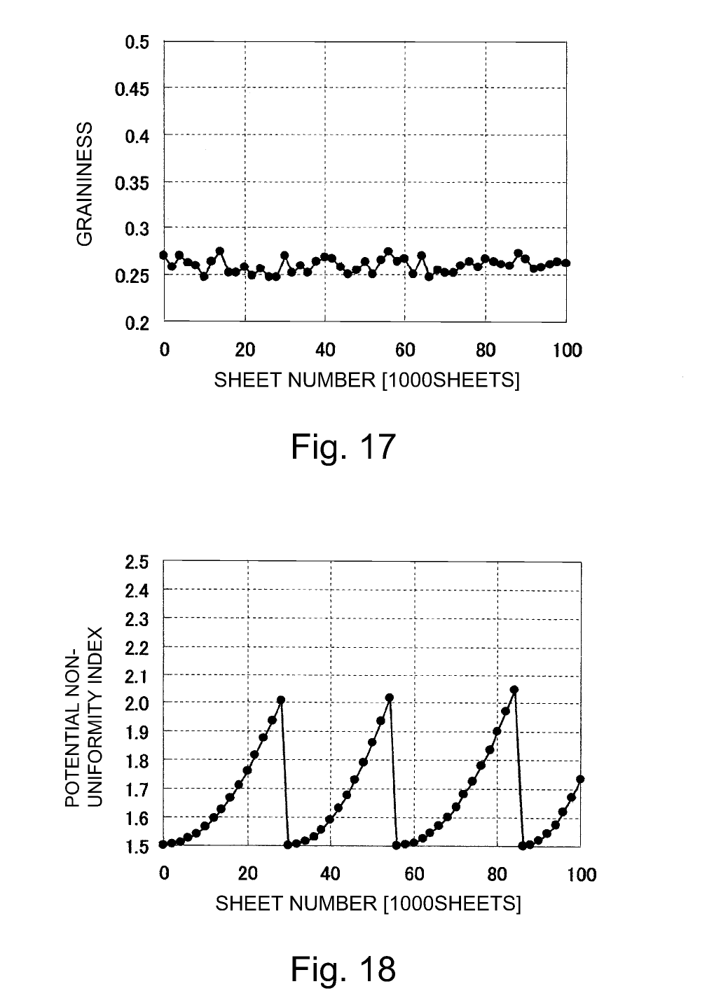

FIG. 17 shows a relationship between the image output sheet number and the graininess. From FIG. 13, it is understood that the graininess is always 3.0 or less and is kept in a good state.

FIG. 18 shows a relationship between the image output sheet number and the potential non-uniformity index. During the image output durability test of 100,000 sheets, the exchange of the fur brush roller 33 is made three times.

Next, the image output durability test was conducted again using the fur brush roller 33 after the exchange, and the graininess at that time was evaluated, so that whether or not the exchange was made at appropriate timing, i.e., whether or not the exchange timing was excessively early was verified. In this case, with respect to three fur brush roller 33 after the exchange, the graininess was evaluated every 1,000 sheets of the image output sheet number.

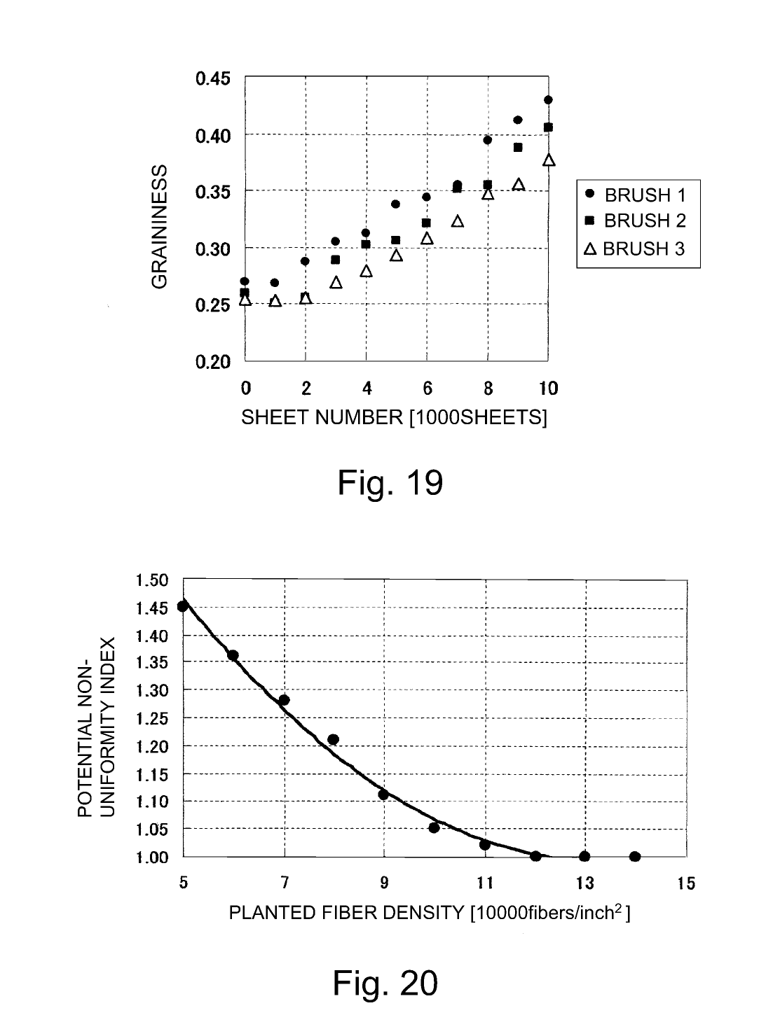

FIG. 19 shows a relationship between the image output sheet number and the graininess. From FIG. 19, it is understood that with respect to any of the brushes, the graininess starts deterioration within 2,000 to 3,000 sheets. In Embodiment 1, the graininess deteriorates within 4,000-6,000 sheets, and therefore it is understood that compared with Embodiment 1, accuracy of lifetime prediction is improved.

As described above, according to this embodiment, the relative speed between the fur brush roller 33 and the photosensitive drum 1 is made small by reducing the peripheral speed of the fur brush roller 33 during the operation of the evaluation sequence, so that the detection sensitivity of the deterioration can be enhanced. As a result, it is possible to more strictly detect the exchange of the fur brush roller 33 and to maintain the image quality at the good level for a long term. Further, according to this embodiment, it is possible to more efficiently use the fur brush roller 33.

### Embodiment 3

Next, another embodiment of the present invention will be described. Basic constitution and operation of an image forming apparatus in this embodiment are the same as those of the image forming apparatus in Embodiment 1. Accordingly, elements having functions and constitutions which are identical or corresponding to those for the image forming apparatus in Embodiment 1 are represented by the same reference numerals or symbols and will be omitted from detailed description.

### 1. Outline

As described above, the minute potential non-uniformity of the photosensitive drum 1 depends on the contact frequency of the filaments 31 capable of injecting the electric charges. Further, the contact frequency of the filaments 31 capable of injecting the electric charges is proportional to the product of the relative speed between the fur brush roller 33 and the photosensitive drum 1 and the planted fiber density of the filaments 31 capable of injecting the electric charges.

Accordingly, by the increase in use amount, the fur brush is in the state as shown in (a) of FIG. 4, so that when the contact density of the filaments 31 capable of injecting the electric charges is lowered, the CPU as the controller effects control so that the relative speed is made large. By this, the contact frequency of the filaments 31 capable of injecting the electric charges is increased, so that the minute potential non-uniformity of the photosensitive drum 1 can be made small.

For example, even when the planted fiber density of the filaments 31 capable of injecting the electric charges is ½ compared with that in the initial stage of use, if the relative speed is made twice, the contact frequency of the filaments 31 capable of injecting the electric charges is equal to the frequency in the initial stage of use. By this, the deterioration of the minute potential non-uniformity of the photosensitive drum 1 can be suppressed.

Incidentally, if the relative speed between the fur brush roller 33 and the photosensitive drum 1 is increased in advance, even when the planted fiber density of the filaments 31 capable of injecting the electric charges is lowered, it is possible to suppress the deterioration of the minute potential non-uniformity of the photosensitive drum 1. However, when the relative speed between the fur brush roller 33 and the photosensitive drum 1 is increased, the lifetime itself of the fur brush roller 33 is shortened, and therefore the fur brush roller 33 is not used efficiently even when the relative speed is increased from the initial stage move than necessary.

In this way, by controlling the relative speed between the fur brush roller 33 and the photosensitive drum 1 correspondingly to the deterioration state of the fur brush roller 33, it would be considered that the fur brush roller 33 can be used efficiently.

In this embodiment, the potential non-uniformity index is obtained, and on the basis of the obtained potential non-uniformity index, the relative speed between the fur brush roller 33 and the photosensitive drum 1 is controlled.

First, the relationship between the planted fiber density of the filaments 31 capable of injecting the electric charges and the potential non-uniformity index was checked at the relative speed between the fur brush roller 33 and the photosensitive drum 1, i.e., at 1300 mm/sec which is the same setting as in Embodiment 1.

A result is shown in FIG. 20. From FIG. 20, by obtaining the potential non-uniformity index when the relative speed is 1300 mm/sec, the planted fiber density of the filaments 31, of the fur brush roller 33, capable of injecting the electric charges is known.

The potential non-uniformity index is, similarly as in Embodiment 1, in accordance with the sequence of FIG. 10, obtained every 2,000 sheets of the image output sheet number at the relative speed of 1300 mm/sec between the fur brush roller 33 and the photosensitive drum 1. The potential non-uniformity index is x.

Then, in this embodiment, if x≦1.1 holds, the relative speed is kept as it is. On the other hand, if x>1.1 holds, from the relationship between the planted fiber density of the filaments 31 capable of injecting the electric charges and the potential non-uniformity index as shown in FIG. 20, the planted fiber density of the filaments 31 capable of injecting the electric charges is obtained. This value is y.

From FIG. 20, when the potential non-uniformity index is 1.1, the planted fiber density of the filaments 31 capable of injecting the electric charges is 92,000 fibers/inch². Accordingly, from the obtained value of y, compared with the planted fiber density of the filaments 31 capable of injecting the electric charges when the potential non-uniformity index is 1.1, it is understood that the planted fiber density of the filaments 31 capable of injecting the electric charges is lowered by y/92,000.

Therefore, the contact frequency is increased by increasing the relative speed between the fur brush roller 33 and the photosensitive drum 1 to 1300×(92,000/y) (mm/sec), so that the potential non-uniformity index can be made 1.1 (relative speed control).

Incidentally, in this embodiment, by computation as described above, the relative speed, between the fur brush roller 33 and the photosensitive drum 1, providing the potential non-uniformity index of 1.1 is obtained, but the relationship between the potential non-uniformity index and a correction value, for the relative speed, necessary to change the potential non-uniformity index to a predetermined value may also be stored as a table or the like.

In this way, in this embodiment, the image forming apparatus includes the control means for controlling the operation condition of the charging member 33 on the basic of the information on the ratio between the obtained charging proportion and the charge-removing proportion. In this embodiment, the CPU 151 functions as this control means. Particularly, in this embodiment, the control means increase the relative speed between the photosensitive member 1 and the charging member 33 during the image formation in the case where the obtained potential non-uniformity index exceeds the predetermined value.

### 2. Control Method

In this embodiment, similarly as in Embodiment 1, the evaluation sequence is performed during the non-image formation every time when the image output sheet number reaches the predetermined number (2,000 sheets).

The control mode of the image forming apparatus 100 in this embodiment is similar to that in Embodiment 1 shown in FIG. 23. In this embodiment, particularly, the CPU 151 changes the peripheral speed of the fur brush roller 33 during the image formation so that the speed is the relative speed obtained in the relative speed control. However, during execution of every evaluation sequence, the peripheral speed of the fur brush roller 33 is made at a constant peripheral speed so as to be predetermined relative speed (1300 mm/sec).

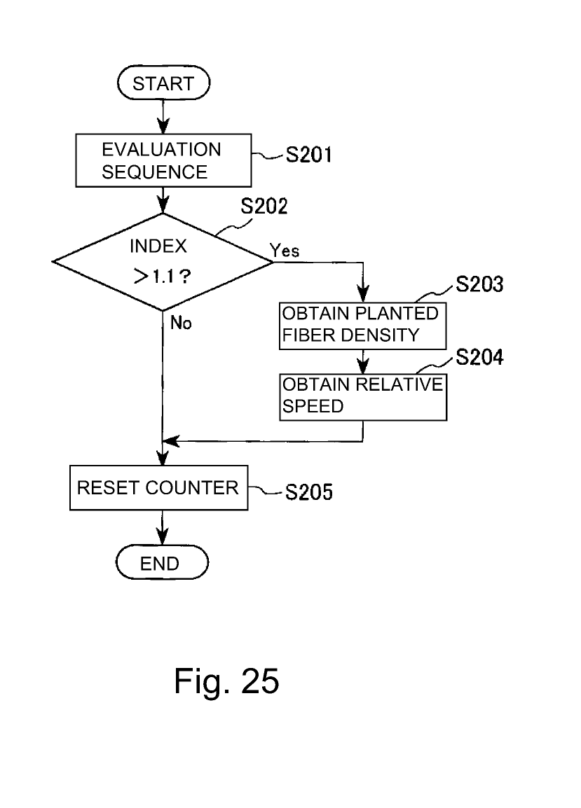

FIG. 25 is a flowchart showing a procedure of the relative speed control for obtaining the relative speed between the fur brush roller 33 and the photosensitive drum 1 during the image formation in this embodiment.

First, the CPU 151 as the executing portion executes the evaluation sequence, and obtains the potential non-uniformity index (S201). This evaluation sequence is executed during the post-rotation or during the sheet interval every time when the number of counts of the image output sheet number by the counter 160 reaches 2,000 sheets.

Next, the CPU 151 discriminates whether or not the potential non-uniformity index obtained in the evaluation sequence exceeds 1.1 which is the threshold, for discriminating the change in relative speed, stored in advance in the ROM 152 (S202).

In the case where the CPU 151 discriminates in S202 that the potential non-uniformity index exceeds 1.1, the CPU 151 obtains the planted fiber density y from the relationship, as shown in FIG. 20, stored in the ROM 152 in advance (S203). Further, from the obtained value of y, by a computing formula stored in the ROM 152 in advance, the CPU 151 obtains the relative speed between the fur brush roller 33 and the photosensitive drum 1 during the image formation (S204). In this embodiment, the peripheral speed of the photosensitive drum 1 is not changed and also the rotational direction of the fur brush roller 33 is not changed, and therefore in this case, specifically, the peripheral speed for providing the above-obtained relative speed is obtained. Thereafter, the number of counts of the counter 160 is reset to 0 (S205), and then the relative speed control is ended.

In S202, in the case where the CPU 151 discriminates that the potential non uniformity index is 1.1 or lees, the CPU 151 resets the number of counts of the counter 160 to 0 (S205), and then ends the relative speed control.

### 3. Effect

In order to check the effect of this embodiment, the image output durability test was conducted up to 100,000 sheets, so that whether or not the graininess was maintained and the fur brush was used efficiently was verified. In this case, the above-described relative speed correction control was effected every 2,000 sheets of the image output sheet number, and at the same time, the G was evaluated.

A degree of the deterioration of the potential non-uniformity index becomes earlier with an increasing image output sheet number. In order to prevent the graininess from starting deterioration during a period from the control to subsequent control, the fur brush roller 33 was exchanged at the time when the potential non-uniformity index exceeded 1.4.

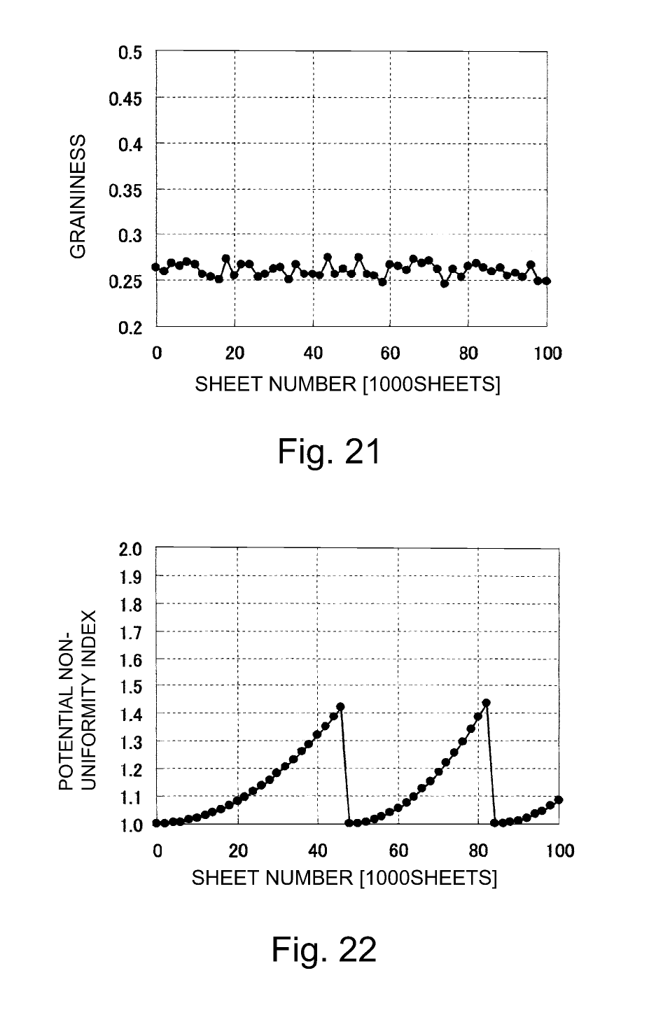

FIG. 21 shows a relationship between the image output sheet number and the graininess. From FIG. 13, it is understood that the graininess is always 3.0 or less and is kept in a good state.

FIG. 22 shows a relationship between the image output sheet number and the potential non-uniformity index. Until the image output of 100,000 sheets is made, the exchange of the fur brush roller 33 is made two times.

In Embodiment 1 in which the speed control for the relative speed was not effected, the exchange of the fur brush roller 33 was made three times until the image was outputted on 100,000 sheets, so that the exchange frequency of the fur brush 33 was once per about 28,000 sheets. On the other hand, in this embodiment, the exchange frequency became one per about 41,000 sheets. As a result, by this embodiment, it is possible to more efficiently use the fur brush roller 33 and to maintain the image quality at the good level for a long term.

### Another Embodiment

As described above, thr present invention was described in accordance with the specific embodiments, but the present invention is not limited to the above-described embodiments.

For example, in the embodiments described above, the fur brush roller was used as the charging brush. However, the present invention is applicable to also a charging system, in which fine particles are contained in the fur brush, and the like.

### INDUSTRIAL APPLICABILITY

According to the present invention, there is provided an image forming apparatus capable of detecting the minute potential non-uniformity of the photosensitive member due to the deterioration of the charging member.

### EXPLANATION OF REFERENCE NUMERALS

1: photosensitive drum
2: pre-exposure lamp
3: fur brush charger
8: potential sensor
31: filament
32: charging sleeve
33: fur brush roller

1. An image forming apparatus comprising:
a rotatable photosensitive member;
a rotatable charging brush for electrically charging said photosensitive member by injecting electric charges into a surface of said photosensitive member in contact with the surface of said photosensitive member;
a power source for applying a voltage to said charging brush;
a potential sensor for detecting a surface potential of said photosensitive member;
an executing portion for removing, after a first potential which is the potential of said photosensitive member provided by charging with a first voltage applied to said charging brush is detected by said potential sensor, the electric charges from said photosensitive member by applying a second voltage smaller in absolute value than the first potential to said charging brush, and for causing said potential sensor to detect a second potential which is the potential of said photosensitive member after removal of the electric charges; and
a notifying portion for providing notification of information on a lifetime of said charging brush or information on exchange of said charging brush on the basis of the first potential and the second potential.

2. An image forming apparatus according to claim 1, comprising a calculating portion for calculating a charging proportion which is a proportion of a potential difference between the first potential and a third potential, which is the surface potential of said photosensitive member before the first voltage is applied to said charging brush, to a potential difference between the third potential and the first voltage and for calculating a charge removing proportion which is a proportion of a potential difference between the first potential and the second potential to a potential difference between the first voltage and the second voltage,
wherein said notifying portion provides notification of the information on the lifetime of said charging brush or the information on the exchange of said charging brush on the basis of the charging proportion and the charge removing proportion which are calculated by said calculating portion.

3. An image forming apparatus according to claim 1, comprising a controller for controlling a relative speed between said photosensitive member and said charging brush,
wherein said controller lowers the relative speed between said photosensitive member and said charging brush during the execution of the detection of the first potential and the second potential by said executing portion.

4. An image forming apparatus comprising:
a rotatable photosensitive member;
a rotatable charging brush for electrically charging said photosensitive member by injecting electric charges into a surface of said photosensitive member in contact with the surface of said photosensitive member;
a power source for applying a voltage to said charging brush;
a potential sensor for detecting a surface potential of said photosensitive member;
an executing portion for removing, after a first potential which is the potential of said photosensitive member charged by applying a first voltage to said charging brush is detected by said potential sensor, the electric charges from said photosensitive member by applying a second voltage smaller in absolute value than the first potential to said charging brush, and for causing said potential sensor to detect a second potential which is the potential of said photosensitive member after removal of the electric charges; and
a controller controlling a relative speed of said charging brush relative to said photosensitive member on the basis of the first potential and the second potential.

5. An image forming apparatus according to claim 4, comprising a calculating portion for calculating a charging proportion which is a proportion of a potential difference between the first potential and a third potential, which is the surface potential of said photosensitive member before the first voltage is applied to said charging brush, to a potential difference between the third potential and the first voltage and for calculating a charge removing proportion which is a proportion of a potential difference between the first potential and the second potential to a potential difference between the first voltage and the second voltage,
wherein said controller contacts the relative speed of said charging brush relative to said photosensitive member on the basis of the charging proportion and the charge removing proportion which are calculated by said calculating portion.

6. An image forming apparatus according to claim 4, wherein said calculating portion calculates a proportion of the charging proportion to the charge removing proportion, and
wherein said controller effects control so that the relative speed of said charging brush relative to said photosensitive member is made large in the case where the proportion of the charging proportion to the charge removing proportion calculated by said calculating portion exceeds a predetermined value.

7. An image forming apparatus according to claim 4, wherein said controller lowers the relative speed between said photosensitive member and said charging brush during the execution of the detection of the first potential and the second potential by said executing portion.
